(19) United States
(12) Patent Application Publication
(10) Pub. No.: US 2002/0178883 A1
(43) Pub. Date: Dec. 5, 2002

(54) Semiconductor wafer cutting method

(76) Inventor: Naoko Yamamoto, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/151,879

(22) Filed: May 22, 2002

(30) Foreign Application Priority Data
Jun. 1, 2001 (JP) 2001-166387

(51) Int. Cl. B28D 1/04; B26D 7/08

(52) U.S. Cl. 83/22; 125/13.01

(57) ABSTRACT

A semiconductor wafer having an adhesive resin layer formed on the back side is cut with a cutting blade driven to rotate. At the time of cutting, the front side of the semiconductor wafer is spurted with a cooling medium such as pure water having a temperature of 15° C. or less, preferably 10° C. or less.

### FIELD OF THE INVENTION

The present invention relates to a method of cutting a semiconductor wafer having an adhesive resin layer formed on the back side.

### DESCRIPTION OF THE PRIOR ART

In the production of a semiconductor device, as is well known, the front side of a semiconductor wafer is divided into a large number of rectangular areas by streets disposed in a lattice form, and a semiconductor circuit is formed in each area. Thereafter, the semiconductor wafer is cut along the streets to separate the rectangular areas individually, thereby forming semiconductor chips. A cutting machine called “dicer” is used to cut the semiconductor wafer. The cutting machine comprises a chuck table for holding the semiconductor wafer in such a manner that its front side faces up and a cutting blade which is driven to rotate. The cutting blade and the chuck table are moved relative to each other, and the cutting blade is applied to the semiconductor wafer to cut the semiconductor wafer. The thus formed semiconductor chips are fixed on a support means such as a lead frame. A suitable adhesive is advantageously used to fix the semiconductor chips on the support means.

In recent years, in order to eliminate the operation of applying an adhesive to the back side of a semiconductor chip or the front side of the support means so as to fix each semiconductor chip on the support means, it has been proposed and actually carried out to form, in advance, an adhesive resin layer which is advantageously formed of a thermoplastic resin, on the back side of a semiconductor wafer before the semiconductor wafer is cut along the streets.

When the adhesive resin layer is formed on the back side of the semiconductor wafer before it is cut, it has been come out that the cutting of the semiconductor wafer involves the following problem. Particularly when the adhesive resin layer is made of a thermoplastic resin, a relatively small cutout is liable to generate on the back side of the cut portion at the time of cutting the semiconductor wafer along the streets. Cuttings formed by the generation of the cutout may be kept adhered to the adhesive resin layer and tends to be fixed on the support means in a state of overflowing the semiconductor chips, when the semiconductor chips are fixed on the support means. Although the cause of generating the cutout on the back side of the cut portion is not always made clear, the inventor of the present invention assumes that this is because the adhesive resin layer is softened by heat generated by cutting and the fixing of the semiconductor wafer on the chuck table becomes unstable.

### SUMMARY OF THE INVENTION

It is an object of the present invention to improve the method of cutting a semiconductor wafer having an adhesive resin layer formed on the back side with a cutting blade driven to rotate thereby to prevent or suppress the generation of a cutout on the back side of the cut site.

The inventor of the present invention has conducted intensive studies and experiments and has found that the generation of a cutout on the back side of the cut portion can be prevented or suppressed by jetting out toward the front side of the semiconductor wafer a cooling medium such as pure water having a temperature of 15° C. or less, preferably 10° C. or less in place of a normal-temperature cooling liquid when the semiconductor wafer is cut with the cutting blade.

That is, according to the present invention, there is provided, as a cutting method which attains the above principal object, a method of cutting a semiconductor wafer having an adhesive resin layer formed on the back side, comprising the steps of: holding the semiconductor wafer on a chuck table in such a manner that its front side faces up; driving a cutting blade to rotate; moving the chuck table holding the semiconductor wafer and the cutting blade which has been driven to rotate, relative to each other in a cutting direction, and applying the cutting blade to the semiconductor wafer and the adhesive resin layer to cut the semiconductor wafer and the adhesive resin layer; and jetting out a cooling medium having a temperature of 15° C. or less toward the front side of the semiconductor wafer when the cutting blade is applied to the semiconductor wafer and the adhesive resin layer.

The cooling medium is preferably pure water having a temperature of 15° C. or less, particularly 10° C. or less. In a preferred embodiment, the semiconductor wafer is mounted in the mounting opening of a frame having the mounting opening in the center, by a tape affixed across the back of the frame and the adhesive resin layer and is kept being sucked to the surface of the chuck table via the tape. The adhesive resin layer is made from a thermoplastic resin and has a thickness of 100 to 200 μm.

### BRIEF DESCRIPTION OF THE DRAWINGS

FIG. 1 is a perspective view showing that a semiconductor wafer to be cut according to a preferred embodiment of the cutting method of the present invention is mounted on a frame:

FIG. 2 is a perspective view of main constituent elements of a cutting machine for carrying out the cutting method of the present invention; and

FIG. 3 is a sectional view showing that a semiconductor wafer and an adhesive resin layer formed on the back side of the semiconductor wafer are cut by the cutting machine of FIG. 2.

### DETAILED DESCRIPTION OF THE PREFERRED EMBODIMENTS

A preferred embodiment of the cutting method of the present invention will be described in detail hereinafter with reference to the accompanying drawings.

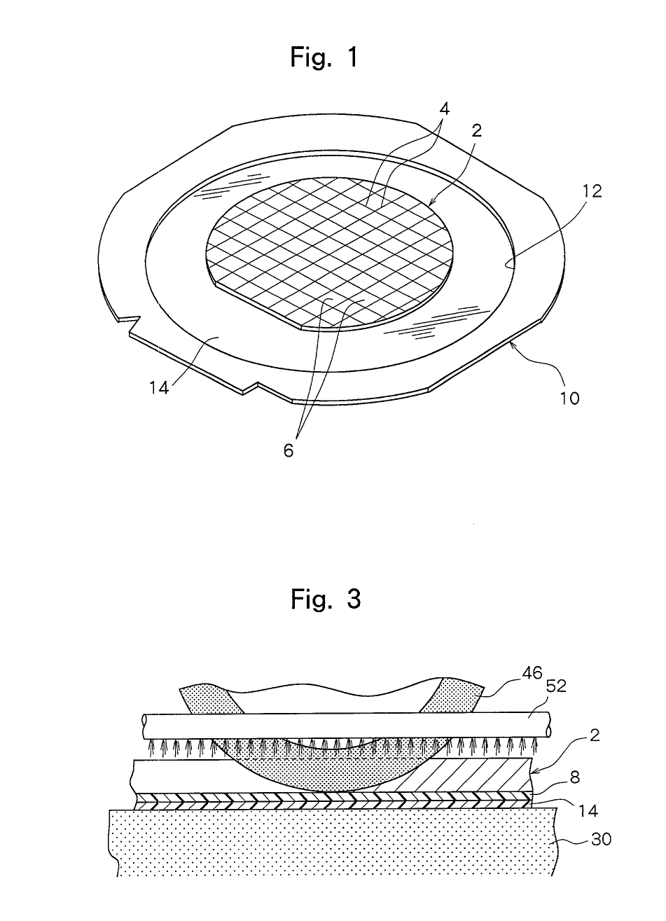

FIG. 1 shows a semiconductor wafer 2 to be cut by the cutting method of the present invention. Streets 4 are disposed in a lattice form on the front side of the semiconductor wafer 2 which is composed of a silicon wafer, and the semiconductor wafer 2 is divided into a large number of rectangular areas 6 by the streets 4. A semiconductor circuit is formed in each of the rectangular area 6. An adhesive resin layer 8 (FIG. 3) is formed on the back side of the semiconductor wafer 2. Preferably, this adhesive resin layer 8 is made of a thermoplastic resin and has a thickness of about 100 to 200 μm. Typical examples of the thermoplastic resin for adhesion include a vinyl-based adhesive and an acrylic adhesive. As shown in FIG. 1, it is appropriate that the semiconductor wafer 2 be mounted on a frame 10 when the semiconductor wafer 2 is to be cut along the streets 4. The frame 10 which can be made of stainless steel or suitable synthetic resin has a circular mounting opening 12 in the center. A tape 14 which extends across the mounting opening 12 is affixed to the back side of the frame 10, and the back side of the frame 10, namely, the adhesive resin layer 8 of the semiconductor wafer 2 is adhered to the tape 14 in such a manner that the front side of the semiconductor wafer 2 faces up, so that the semiconductor wafer 2 is mounted in the mounting opening 12.

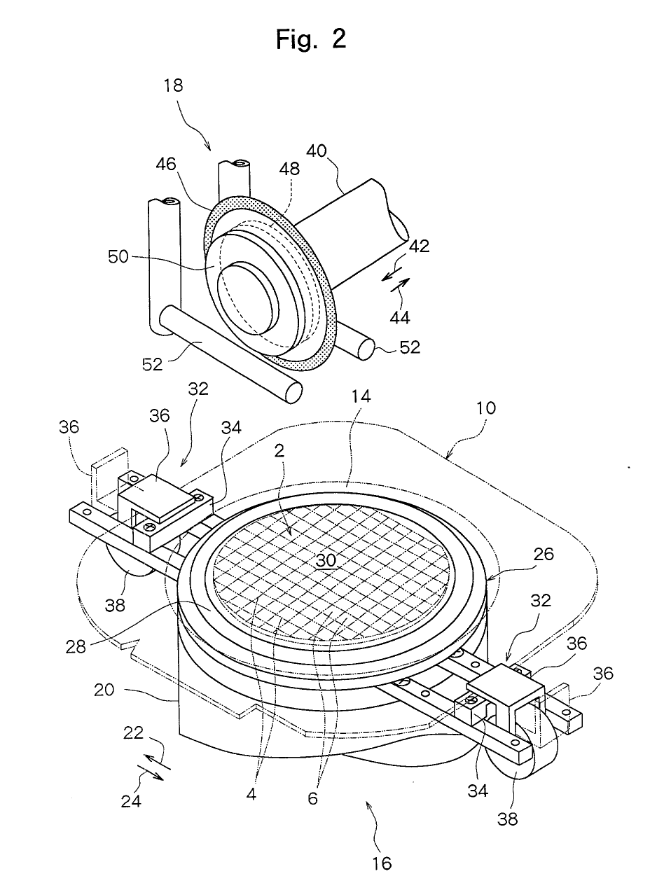

A cutting machine called “dicer” is advantageously used to cut the semiconductor wafer 2. Describing with reference to FIG. 2 which schematically shows the main constituent elements of the cutting machine, the cutting machine comprises a chuck table assembly designated as a whole at 16 and a cutting unit as a whole designated at 18.

The chuck table assembly 16 shown in the figure comprises a substantially cylindrical driven support 20. This driven support 20 is mounted in such a way that it can move substantially horizontally in directions shown by arrows 22 and 24 and can rotate on the center axis extending substantially vertically. The driven support 20 is provided with a chuck table 26. The chuck table 26 shown in the illustrated embodiment comprises a base 28 and a chuck plate 30. The base 28 is shaped like a disk and secured to the top end of the driven support 20. A circular depression is formed in the top surface of the base 28, and the chuck plate 30 is fixed in this circular depression. The disk-like chuck plate 30 is made of a porous material such as a porous ceramic. A suction path (not shown) communicating with the circular depression of the base 28 is formed in the base 28 and the driven support 20, and the chuck plate 30 formed from a porous material is selectively coupled to a vacuum source (not shown) through the suction path. The chuck table 26 is provided with a pair of frame holding means 32. Each of the frame holding means 32 comprises a fixed holding piece 34, movable holding piece 36 and air pressure actuator 38, and the movable holding piece is pivotably moved between a closed position shown by a solid line and an open position shown by a two-dot chain line, by the air pressure actuator 38.

The cutting unit 18 comprises a rotary shaft 40. This rotary shaft 40 is rotatably mounted, can move substantially horizontally in directions shown by arrows 42 and 44 and also can move up and move down in a substantially vertical direction. The directions shown by the arrows 42 and 44 are substantially perpendicular to the directions shown by the arrows 22 and 24. The rotary shaft 40 is fitted with a cutting blade 46. The cutting blade 46 has an annular hub portion and an annular blade portion formed at the periphery of the hub portion, and is detachably mounted to the rotary shaft 40 by holding the hub portion of the cutting blade 46 between an inner flange member 48 fixed to the rotary shaft 40 and an outer flange member 50 fixed to this inner flange member 48. The blade portion of the cutting blade 46 is advantageously formed by bonding together diamond grains by means of a suitable binder. The cutting unit 18 also comprises a pair of cooling medium jet nozzles 52 disposed on both sides of the cutting blade 46. The cooling medium jet nozzles 52 are each mounted to a mounting block (not shown) to which the rotary shaft 40 is mounted, so as to be moved in directions shown by the arrows 42 and 44 and also to be moved up and moved down in a substantially vertical direction together with the cutting blade 46. A large number of holes are formed in the under-surface of each of the cooling medium jet nozzles 52 extending substantially horizontally on both sides of the lower end of the cutting blade 46 in order to jet out a cooling medium supplied from a cooling medium supply source (not shown). The jetting-out of the cooling medium will be further described later.

Describing a typical example of the cutting mode of the semiconductor wafer 2 using the cutting blade 46, before the start of cutting, the semiconductor wafer 2 to be cut and the cutting blade 46 are brought to the position as required. That is, the longitudinal direction of a group of streets 4 extending parallel to one another in a predetermined direction of the streets 4 on the front side of the semiconductor wafer 2 is aligned with the directions shown by the arrows 22 and 24, and further, the cutting blade 46 is aligned with one of the streets 4 of the group in the directions shown by the arrows 42 and 44. As for the position in the vertical direction of the cutting blade 46, the lower end of the cutting blade 46 is caused to reach the under-surface of the adhesive resin layer 8 formed on the back side of the semiconductor wafer 2, namely, the top surface of the tape 14. Then, the cutting blade 46 is rotated at a high revolution speed, for example, 30,000 to 40,000 rpm, and the chuck table assembly 16 is moved at a speed of 50 to 100 mm/sec. in the cutting direction shown by the arrow 22. Thus, the semiconductor wafer 22 is cut along one street 4 together with the adhesive resin layer 8 formed on the back side thereof by the function of the cutting blade 46. The tape 14 is not cut substantially. Then, the cutting unit 18 is slightly moved up, and the chuck table assembly 16 is returned in the direction shown by the arrow 24. Thereafter, the cutting unit 18 is moved in the indexing direction shown by the arrow 42 or 44 to align the cutting blade 46 with the next street 4, and the cutting unit 18 is moved down by a predetermined amount. Then, the chuck table assembly 16 is moved in the cutting direction shown by the arrow 22, and the semiconductor wafer 2 and the adhesive resin layer 8 formed on the back side thereof are cut along the next street 4. When the above cutting is repeated and cutting along the group of streets 4 extending parallel to one another in the predetermined direction is completed, the chuck table assembly 16 turned at 90° and cutting along the other group of streets 4 is performed.

In the cutting method constituted according to the present invention, it is important that when the semiconductor wafer 2 and the adhesive resin layer 8 formed on the back side thereof are to be cut with the cutting blade 46, a cooling medium be jetted out toward the front side of the semiconductor wafer 2 from the cooling medium jet nozzles 52 as shown in FIG. 3 and that the jetted cooling medium should have a temperature of 15° C. or less and not normal temperature. The preferred cooling medium is pure water having a temperature of 15° C. or less, particularly 10° C. or less. The amount of the cooling medium jetted is 2,000 to 4,000 cm³/min. According to the experience of the inventor of the present invention, when the cooling medium jetted-out from the cooling medium jet means 52 has normal temperature, a cutout is liable generate on the back side of the cut portion of the semiconductor wafer 2. When the temperature of the cooling medium to be jetted-out from the cooling medium jet means 52 is set to 15° C. or less, preferably 10° C. or less, the generation of the cutout can be prevented or suppressed.

What is claimed is:

1. A method of cutting a semiconductor wafer having an adhesive resin layer formed on the back side, comprising the steps of:
holding the semiconductor wafer on a chuck table in such a manner that its front side faces up;
driving a cutting blade to rotate;
moving the chuck table holding the semiconductor wafer and the cutting blade which has been driven to rotate, relative to each other in a cutting direction, and applying the cutting blade to the semiconductor wafer and the adhesive resin layer to cut the semiconductor wafer and the adhesive resin layer; and
jetting out a cooling medium having a temperature of 15° C. or less toward the front side of the semiconductor wafer when the cutting blade is applied to the semiconductor wafer and the adhesive resin layer.

2. The cutting method of claim 1, wherein the cooling medium is pure water having a temperature of 15° C. or less.

3. The cutting method of claim 2, wherein the cooling medium is pure water having a temperature of 10° C. or less.

4. The cutting method of claim 1, wherein the semiconductor wafer is mounted in the mounting opening of a frame having the mounting opening in the center, by a tape affixed across the back side of the frame and the adhesive resin layer and is kept being sucked to the surface of the chuck table via the tape.

5. The cutting method of claim 1, wherein the adhesive resin layer is made from a thermoplastic resin and has a thickness of 100 to 200 μm.
